(19) United States
(12) Patent Application Publication
(10) Pub. No.: US 2003/0078938 A1
(43) Pub. Date: Apr. 24, 2003

(54) Database and method of storing and retrieving data

(75) Inventor: Gary Paul Noble, Nr Broadway (GB)

Correspondence Address: John L. Rogitz, Rogitz & Associates, Suite 3120, 750 B Street, San Diego, CA, 92101, US

(73) Assignee: International Business Machines Corporation, Armonk, NY

(21) Appl. No.: 10/272,639

(22) Filed: Oct. 16, 2002

(30) Foreign Application Priority Data
Oct. 19, 2001 (GB) 0125165.1

(51) Int. Cl. G06F 17/00

(52) U.S. Cl. 707/102

(57) ABSTRACT

A database is provided with a plurality of data items (102). The database includes at least one link structure (104) between two data items (102). A link structure (104) refers to the two data items (102) it connects and includes data (122) relating to the relationship between the two data items (102). A user interface (200) is provided for navigating the database using the data items (102) and link structures (104) to access related data items (102) and link structures (104). The database includes means for adding new data items (102) and defining new link structures (104) between data items (102) through the user interface (200).

### I. FIELD OF THE INVENTION

This invention relates to a database and a method of storing, navigating and retrieving data.

### II. BACKGROUND OF THE INVENTION

Information may exist in difficult to use databases or on paper filed in locations which are not immediately accessible. Expertise may also exist in people who are unavailable due to leave, other work commitments or who have left a company. The inter-relation of data items is often as important as the data or information itself. Cross-references and relationships between data items can lead to data in a completely separate field which is relevant.

Relational databases store information in tables with rows and columns of data. A database management system can conduct searches by using data in specified columns of one table to find additional data in another table. In relational databases, rows of a table represent records (collections of information about separate items) and the columns represent fields (particular attributes of a record). In conducting searches, a relational database matches information from a field in one table with information in a corresponding field of another table to produce a third table that combines requested data from both tables. In other words, a relational database uses matching values in two tables to relate information in one to information in the other.

However, traditional relational databases can only be used effectively if a field is known to be common to more than one table and therefore the inter-relationship between data item or types of data items needs to be already known in order to access the relevant items. The information in a database in the form of a data item can only be used if, firstly its existence is known about, and secondly its location in a database is known.

In business environments information is collected on many different levels which is inter-related. For example, information may be collected relating to a company's computer systems for use by the teams supporting them. The teams may collect information about the customer's computer systems on many levels from management consultants to programmers. The present invention provides a framework that enables the different levels of information to be collected, connected and used effectively. A subject company itself may also use the framework as a database tool to build up information and benefit from the expertise about their systems that has been gathered over time by the support teams.

People think in terms of items of information but knowledge is typically held as relationships between items of information. The connections may be equal relationships, sub-sets, associations, etc. An aim of the present invention is to use such connections or relationships in a database structure.

An object of the present invention is to provide a database tool which enables the effective collection, storage and retrieval of inter-related information. The described database allows complex information to be presented and navigated through a user interface with simple presentation without exposing the user to large amounts of data. The information is presented in a relationship manner so items of information can be seen in context with links to other items of information.

### SUMMARY OF THE INVENTION

According to a first aspect of the present invention there is provided a database comprising: means for storing plurality of data items, means for providing at least one link structure between two data items, a link structure referring to the two data items and including data relating to the relationship between the two data items; a user interface for navigating the database using the data items and link structures to access related data items and link structures; wherein the database includes means for adding new data items and defining new link structures between data items through the user interface.

Preferably, each data item and each link structure has a plurality of associated attributes. The attributes may include dates, reference numbers, text items, external data references, descriptive data, user information etc.

Preferably, the data items are sorted in a classification system. The classification system may be a hierarchical system with a domain, category and name uniquely identifying a data item.

The database may include template means for adding new data items and defining new link structures, the template means including data item models and link structure models. The data item models and the link structure models may be special types of data items and link structures.

A plurality of data items may be selected as belonging to a set independent of the classification system. A set may be placed in a set by an external application.

A link structure may refer to a first data item and with an open end for attachment to an unspecified second data item.

The database may include access control means in which access to means for adding or deleting data items and link structures is restricted to certain users of the database.

Attributes of data items or link structures may include a record of the creation of and changes to data items or link structures by a user together with the time of the creation or change.

Intelligent agents may be provided for finding routes between two data items using the link structures. Intelligent agents may be provided for alerting a user to the addition of a new data item or link structure in a given classification or set.

A first graphical user interface may be provided with a means for showing a data item and all associated link structure from the data item.

A second graphical user interface may be provided with a means for showing a link structure and details of the two data items linked by the link structure.

According to a second aspect of the present invention there is provided a method of storing and retrieving data in a database including: defining a plurality of data items; defining at least one link structure between two data items, a link structure referring to the two data items and including data relating to the relationship between the two data items; navigating the data using the data items and link structures to access related data items and link structures; the method including adding new data items and defining new link structures between data items.

Preferably, the method includes defining a plurality of attributes associated with each data item and each link structure.

Preferably, the data items are classified in a classification system. The classification system may be a hierarchical system with a domain, category and name uniquely identifying a data item.

The method may include using a template means for adding new data items and link structures, the template means including model data items and link structures.

The method may include defining selected data items as belonging to a set independent of the classification system.

The method may include adding a link structure referring to a first data item and with an open end for attachment to an unspecified second data item.

Access to means for adding, amending or deleting data items and link structures may be controlled.

The method may include recording details of a user adding, amending or deleting a data item or a link structure as an attribute of the data item or link structure together with the time of the change.

The method may include finding routes between two data items via the link structures using an intelligent agent. The method may also include alerting a user to a new data item or link structure in a given classification or set.

According to a third aspect of the present invention there is provided a computer program product stored on a computer readable storage medium, comprising computer readable program code means for performing the steps of: defining a plurality of data items; defining at least one link structure between two data items, a link structure referring to the two data items and including data relating to the relationship between the two data items; navigating the data using the data items and link structures to access related data items and link structures; and adding new data items and defining new link structures between data items.

### BRIEF DESCRIPTION OF THE DRAWINGS

A preferred embodiment of the invention will now be described in detail by way of example only with reference to the following drawings:

FIG. 1A is a schematic diagram of inter-related data items in a database in accordance with the present invention;

FIG. 1B is a diagram of a logical model of the database of FIG. 1A;

FIG. 2A is a user interface for a data management system in accordance with the present invention in a first instance;

FIG. 2B is the user interface of FIG. 2A in a second instance;

FIG. 2C is the user interface of FIG. 2A in a third instance; and

FIG. 3 is a schematic diagram of a data management system with templates for adding data items in accordance with the present invention.

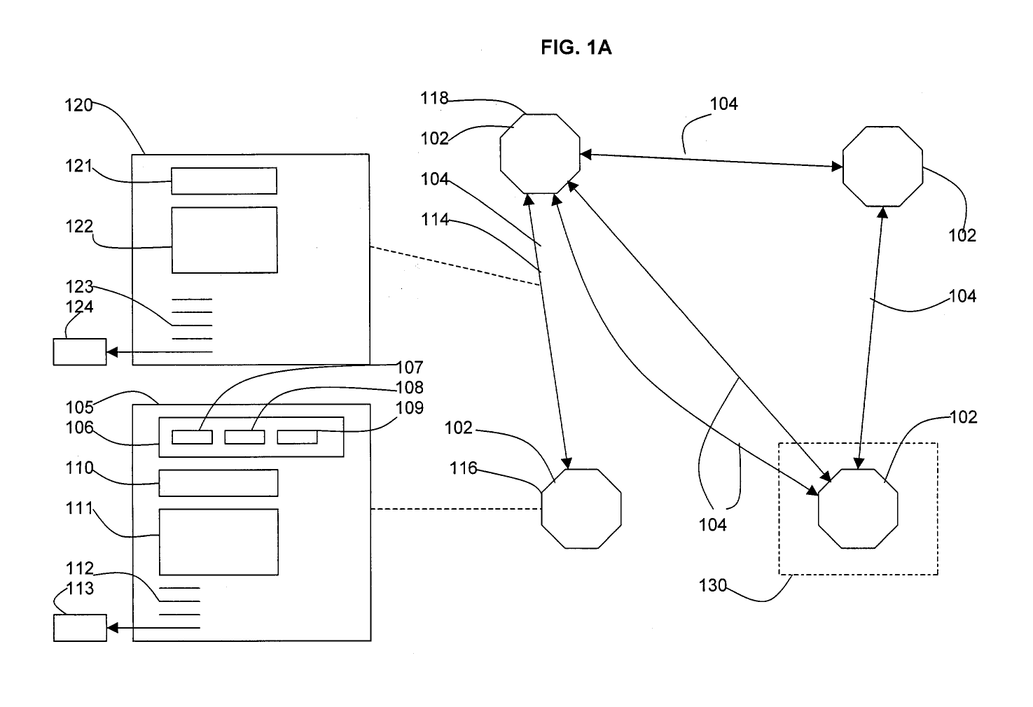

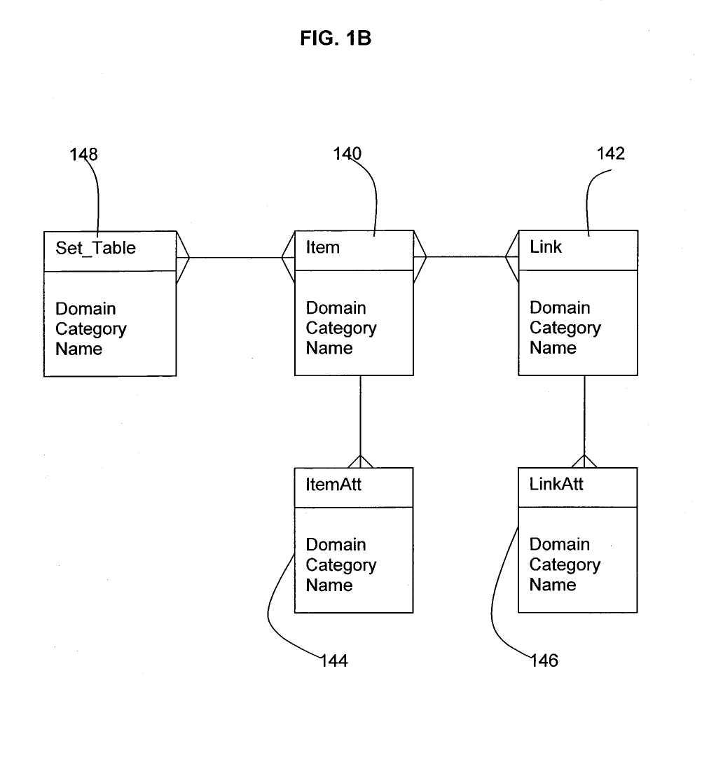

Referring to FIG. 1A, a database is shown in a schematic form. The database is an integrated collection of files of data stored in a structured form in a memory. In the database are stored data items 102. Each data item 102 has information 105 relating to it, including an identification or address 106 in the form of a high level grouping of domain 107, a category 108 which is a subset of the domain 107 and a name 109 for the item of data 102. The three values uniquely define an item of data 102 within the database.

Each data item 102 also has a descriptive title 110, an abstract 111 in the form of details of the data item and listed attributes 112. The listed attributes can include dates, reference numbers, text items, external data references 113, etc.

Each data item 102 can be connected to other data items 102 by means of link structures 104. A link structure or link 104 defines data relating to the relationship between two data items 102. Each link 104 references two data items 102 and is bi-directional between the two data items 102. In other words, a link 114 between a first data item 116 and a second data item 118 will point from the first data item 116 to the second data item 118 and from the second data item 118 to the first data item 116.

Each link 104 also has information stored 120 relating to the link. The stored information 120 includes a descriptive name 121, an abstract 122 describing the relationship represented by the link 104, and listed attributes 123. As in the case of the listed attributes for the data items 102, the listed attributes 123 can include dates, reference numbers, text items, external data references 124, etc. Attributes 122 can also contain user details including the original author of a data item and users amending the data item.

The links 104 can relate a data item 102 to many other data items 102. There may also be more than one link 104 between the same two data items 102. This can occur when there are two or more different relationships between the same two data items 102.

The logical design of the database includes tables for the entities of data items, data item attributes, links, link attributes and sets. A diagram of the logical model for the described database is shown in FIG. 1B. Tables are provided for data items 140, links 142, data item attributes 144, link attributes 146 and sets 148. Each table contains identifying information in the form of the domain, category and name of each entry in the tables. The entities are mapped onto a physical data model. Each table 140, 142, 144, 146, 148 is described in terms of the columns it contains and primary and secondary indices which control access to it.

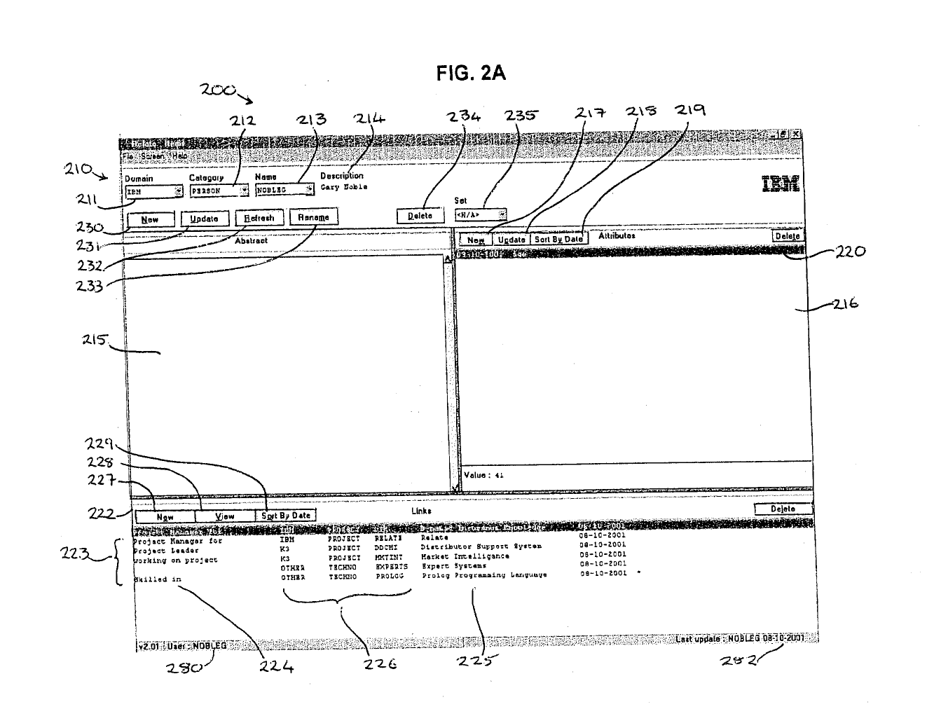

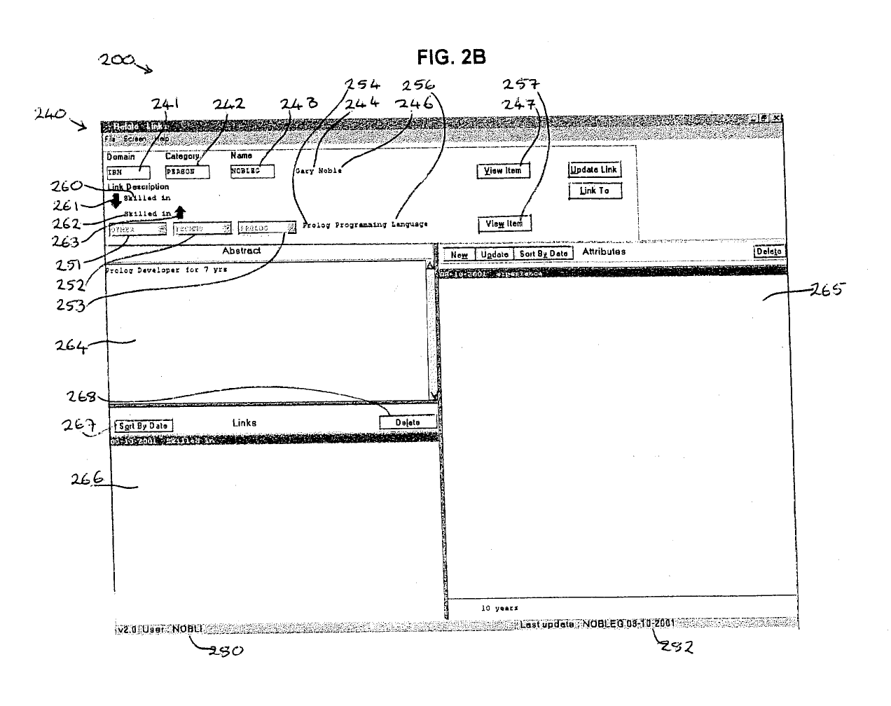

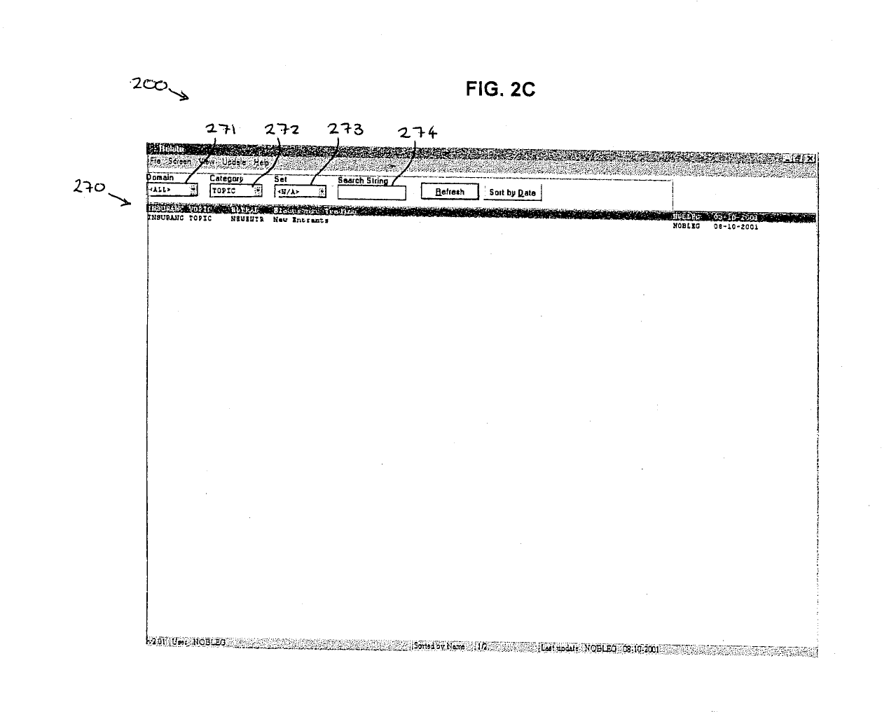

Referring to FIGS. 2A, 2B and 2C, the database has a user interface 200. In a first instance or view 210 of the user interface 200 shown in FIG. 2A, the information relating to a data item 102 is shown. The information contained in this view 210 of the interface 200 includes the information shown in box 105 of FIG. 1. This information 105 includes the identification 106 for a data item, including a domain 107, a category 108 and a name 109. This embodiment uses a hierarchical classification although other means of sorting or addressing could equally be used. The identification 106 operates as a means of cutting through the information contained in the database to access a required data item.

The first view 210 of the user interface 200 includes pull-down menus 211, 212 and 213 for the domain, category and name respectively of a data item. The menus 211, 212, 213 present lists of possible options in each classification that can be selected. If a particular domain is selected from the domain menu 211, for example “IBM” as shown in FIG. 2A, the category menu 212 will provide a list of categories within the domain of “IBM”. Similarly, if a category is chosen, the name menu 213 will provide a list of the names of data items within the category which may be selected for viewing. Wildcards are provided in the pull-down menus for the domain and category in the form of <A11> selections. The wildcard in the domain menu 211 enables all the categories to be shown. The wildcard in the category menu 212 enables all the names to be shown.

When a name of a data item is selected in the name menu 213, the description 214 of the data item is displayed. An abstract box 215 is also displayed containing the details of the data item which may be description of the data item, a piece of data, an image, etc.

An attribute box 216 is also displayed which contains a list of attributes 220 of the data item, for example, the attributes 220 may include the date a data item was entered, a reference number, or any other piece of data relating to the data item. The attribute box 216 can contain an attribute 220 which points to an external source of data, for example, a reference book or paper file. Option buttons 217, 218, 219 are provided for editing the information in the attribute box 216 by adding a new attribute 217, updating an attribute 218, sorting attributes by date 219, etc.

Also provided in the first view 210 is a link box 222 which provides a list of links 223 from the data item which has been selected in the first view 210 of the interface 200. The list of links 223 includes the description of the link 224, the name of the data item 225 to which the link 224 points, the address details 226 of the data item 225 to which the link 224 points and any other selected attributes of the link and/or the data item to which the link points. The link box 222 has a button 227 for adding a new link from the data item shown in the first view 210. The link box 222 also has a selection button 228 for viewing a link by moving to a link screen with full details of the selected link. The link box 222 also has a button 229 for changing the list of links 223 in the link box 222 to sort the links by name or by date. If there are a large number of links 223 listed in box 222, the links can be summarized together, for example by the category or domain of the data item to which the links point.

The information provided in the first view 210 is equivalent to the dashed box 130 drawn around a data item 102 in FIG. 1. The information includes the information from box 105 and the details of the links 104 connecting the data item 102 to other data items 102. When a data item is viewed in the first view 210 the context of the information of the data item is provided by the descriptions of the links from the data item as well as the functionality of the data item.

The first view 210 of the user interface 200 includes means for adding 230 a new data item, updating 231, refreshing 232, renaming 233 or deleting 234 a data item. The addition and amendment of data items is discussed in more detail below.

The first view 210 also provides a means for selecting a preselected set 235 of data items which have been grouped together outside their domain and category classification. The means for selecting a data item in a set 235 is provided in the form of a pull-down menu which lists the sets. Data items are placed into a set by external applications. If an external application wishes to identify a results set of items meeting some criteria, the data items will be added into a set.

A second instance or view 240 of the user interface 200 of the database is shown in FIG. 2B. This view 240 shows a selected link between two data items. The second view 240 can be obtained by selecting a link 223 in the link box 222 of the first view 210.

The second view 240 has fields 241, 242 and 243 for the domain, category and name respectively of a first data item 244. The boxes 241, 242, 243 present the address of a first data item 244 from which a selected link is connected. The display includes the description 246 of the first data item 244 and a button 247 for transfer to a first view 210 for that data item.

The second view 240 also contains fields 251, 252, 253 for the domain, category and name respectively of a second data item 254. The display includes the description 256 of a selected second data item 254 and a button 257 for transfer to a first view 210 for that data item.

Between the displays of the first and second data items 244, 254, a description 260 of a link between the first and second data items 244, 254 is provided with an arrow 261 indicating the direction of the description 260 of the link. A link may have a different description 262 for the link provided in the opposite direction 263.

The second view 240 of the interface 200 provides an abstract box 264 in which details of the link between the two data items 244, 254 are provided. An attribute box 265 provides details of attributes of the link in a similar manner to the attribute box 216 of the first view 210.

A link box 266 is also provided in the second view 240 which provides details of other links between the same two data items 244, 254. The link box 266 includes means for altering the view of the links 267 and deleting a link 268; however, a new link must be added using the link box 222 of the first view 210.

FIG. 2C shows a third instance or view 270 of the interface 200 which provides a summary of data items sorted by the classification details of domain 271, category 272, set 273 by means of pull-down menus. A search box 274 is provided for entering a search string for a data item. Data items are displayed which satisfy search criteria.

When a user uses the described database, the user must log on providing a user name and, if required for security, a password. The user name is used to track and annotate information. Any amendments made to the database can be recorded as being made by the user with a time and date recorded. This information is included as an attribute to the data item or link that has been amended. The information as to who entered or amended a data item or link helps knowledge transfer by showing who entered information and at what time and date. During use of the interface 200 by a user, the user name appears 280 in the view 210, 240, 270. The name of the last user to update 282 the field being viewed is also displayed.

Users can be allowed varying levels of access to the database for amending records and adding new data items and links, in order for control of the data to be maintained. The user name is used to identify different capabilities available to the user. The capabilities of users can be defined by the following user types which are described in the order of greatest access becoming more restricted.

Administration users can create new users. Users are created as data items with attributes that define the password and access rights of the user. Administration users can modify various system features and can see system information.

Write users can create any item or link and adding attributes to both items and links.

Enforced users are limited to creating items, links and attributes that are predefined by templates. This means that the enforced users cannot create items, links or attributes ad-hoc, but are constrained within certain template items, links and attributes.

Read users can only read information and cannot add items, links or attributes.

Templates are provided for defining new data items, links and attributes to be added to the database. Other data items, links and attributes can be added outwith the templates to create such non-standard items, if a user has authorization. The combination of templates and enforced use enables databases to be defined with a particular meta-model and only items of information conforming to this metamodel can be created. This stops naive users from creating new domains and categories and hence creating confusion while maintaining the flexibility of the database for administration and write users.

In the described embodiment, a template is an item of data with the following naming convention <Domain><Category><#temp1>. It will be appreciated that templates can be implemented in other ways. If an item is created with this naming convention (where the domain and category are variables) then they will be treated and used as templates. Any links and attributes on these items will also be treated as part of the template. Templates are provided for supporting data items, links and attributes on both data items and links. Thus a metamodel is created by creating specific named templates with attributes and links. If the user is restricted to enforced mode then the user cannot create other information. This maintains referential integrity of the model. The templates are not static and can be altered over time to add or remove further metadata.

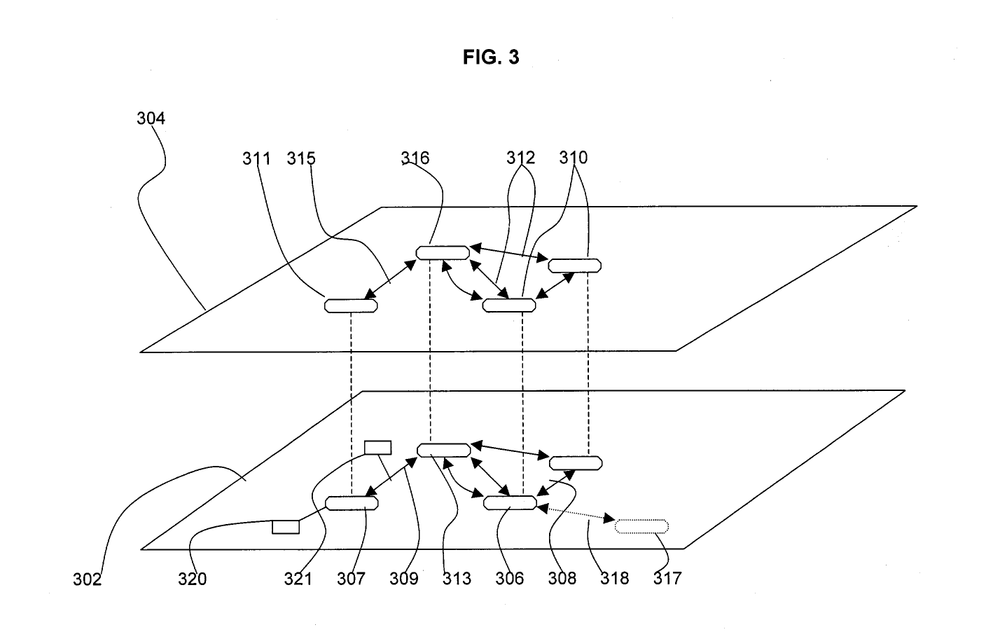

FIG. 3 is a schematic representation of the use of templates for adding data items and links to the described database. FIG. 3 shows a template layer 302 underneath a data layer 304. The template layer 302 has a number of defined templates for data items such as 306 and links such as 308 between data item templates 306. The data item templates 306 and link templates 308 correspond to data items 310 and links 312 which can be added in the data layer 304. Templates for data items and links are a special form and use of data items and links.

For example, a data item template 307 may be a template for <CompanyX><Person><#temp1>. A user who wishes to add a new data item 311 for a new person in the company X uses the data item template 307 and defines the person's name. The data item template 307 has existing suggested link templates 309 to a data item template 313 <CompanyX><Location><#temp1>. The user adds a corresponding link 315 from the data item 311 to a new data item 316 for the location of the person.

The template layer 302 in FIG. 3 shows that the templates for the data items and links are not fixed and can be added to by an authorized user in the form of new data item templates 317 and link templates 318. Each data item template 306 and link template 308 has attribute templates 320, 321 which suggest attributes for a new data item or link being created from a template.

The described means of adding new data items and links provides a flexibility for the data structures. The data is not constrained within the predefined metamodels defined by the templates.

Users can also create links to non-existent data items by creating a link with an open end for attachment to an unspecified second data item. If another user also links another item of data to the unspecified data items, then it will be possible to see and navigate these items that were not explicitly defined. This is done by creating an empty item as the destination data item for a link.

The data management system can be operated in a multi-user environment and functionality ensures that multiple users do not create inconsistent information. The data management system can also operate using a stand-alone database that can either be a separate physical database or a replica of a central database. If a replica, then any information modified in the data (including created and deleted information) in the database will be shared with the master copy and visa versa. This maximizes information transfer and all system information is also replicated as it is represented as items in the database.

The fundamental storage of knowledge as relationships/links means that the information takes the form of a semantic network. In other words a network of information which represents some concept of higher informational concept. By storing data in this way, it is suitable for path finding algorithms to be executed to infer further knowledge and relationships. The data structures are able to be read and processed by external agents that can either be triggered or “wake-up”. These agents can make user of the data, report back to the user or add further information to the information database.

The described data management system enables users to create, manage and share the links that they want in a database. Relationships can be controlled and expressed explicitly and can be processed by other computing systems. Attributes can be added to relationships and items of information. The links provide a means of navigating the database and providing a context for data items by reference to linked data items.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

I claim:

1. A database comprising:
means for storing plurality of data items, means for providing at least one link structure between two data items, a link structure referring to the two data items and including data relating to the relationship between the two data items;
a user interface for navigating the database using the data items and link structures to access related data items and link structures;
wherein the database includes means for adding new data items and defining new link structures between data items through the user interface.

2. A database as claimed in claim 1, wherein each data item and each link structure has a plurality of associated attributes.

3. A database as claimed in claim 1, wherein the data items are sorted in a classification system.

4. A database as claimed in claim 1, wherein the database includes a template means for adding new data items and defining new link structures, the template means including data item models and link structure models.

5. A database as claimed in claim 3, wherein a plurality of data items can be selected as belonging to a set independent of the classification system.

6. A database as claimed in claim 1, wherein a link structure can refer to a first data item and with an open end for attachment to an unspecified second data item.

7. A database as claimed in claim 1, wherein the database includes access control means in which access to means for adding or deleting data items and link structures is restricted to certain users of the database.

8. A database as claimed in claim 1, wherein attributes of data items or link structures include a record of the creation of and changes to data items or link structures by a user together with the time of the creation or change.

9. A database as claimed in claim 1, including intelligent agents for finding routes between two data items using the link structures.

10. A database as claimed in claim 1, including intelligent agents for alerting a user to the addition of a new data item or link structure in a given classification or set.

11. A database as claimed in claim 1, wherein a first graphical user interface is provided with a means for showing a data item and all associated link structure from the data item.

12. A database as claimed in claim 1, wherein a second graphical user interface is provided with a means for showing a link structure and details of the two data items linked by the link structure.

13. A method of storing and retrieving data including:
defining a plurality of data items;
defining at least one link structure between two data items, a link structure referring to the two data items and including data relating to the relationship between the two data items;
navigating the data using the data items and link structures to access related data items and link structures;
the method including adding new data items and defining new link structures between data items.

14. A method as claimed in claim 13, wherein the method includes defining a plurality of attributes associated with each data item and each link structure.

15. A method as claimed in claim 13, wherein the data items are classified in a classification system.

16. A method as claimed in claim 13, wherein the method includes using a template means for adding new data items and link structures, the template means including model data items and link structures.

17. A method as claimed in claim 15, wherein the method includes defining selected data items as belonging to a set independent of the classification system.

18. A method as claimed in claim 13, wherein the method includes adding a link structure referring to a first data item and with an open end for attachment to an unspecified second data item.

19. A method as claimed in claim 13, wherein access to adding, amending or deleting data items and link structures is controlled.

20. A method as claimed in claim 13, wherein the method includes recording details of a user adding, amending or deleting a data item or a link structure as an attribute of the data item or link structure together with the time of the change.

22. A method as claimed in claim 13, wherein the method includes alerting a user to a new data item or link structure in a given classification or set.

23. A computer program product stored on a computer readable storage medium, comprising computer readable program code means for performing the acts of:
defining a plurality of data items;
defining at least one link structure between two data items, a link structure referring to the two data items and including data relating to the relationship between the two data items;
navigating the data using the data items and link structures to access related data items and link structures; and
adding new data items and defining new link structures between data items.

24. A computer program product as claimed in claim 23, wherein the acts include defining a plurality of attributes associated with each data item and each link structure.

25. A computer program product as claimed in claim 23, wherein the data items are classified in a classification system.

26. A computer program product as claimed in claim 23, wherein the acts include using a template means for adding new data items and link structures, the template means including model data items and link structures.

27. A computer program product as claimed in claim 25, wherein the acts include defining selected data items as belonging to a set independent of the classification system.

28. A computer program product as claimed in claim 23, wherein the acts include adding a link structure referring to a first data item and with an open end for attachment to an unspecified second data item.

29. A computer program product as claimed in claim 23, wherein access to adding, amending or deleting data items and link structures is controlled.

30. A computer program product as claimed in claim 23, wherein the acts include recording details of a user adding, amending or deleting a data item or a link structure as an attribute of the data item or link structure together with the time of the change.

31. A computer program product as claimed in claim 23, wherein the acts include finding routes between two data items via the link structures using an intelligent agent.

32. A computer program product as claimed in claim 23, wherein the acts include alerting a user to a new data item or link structure in a given classification or set.
